(19) United States
(12) Patent Application Publication
(10) Pub. No.: US 2012/0266856 A1
(43) Pub. Date: Oct. 25, 2012

(54) Heat and Grease Deflector for a Barbecue Grill

(75) Inventors: Leonard ZELEK, Chicago, IL (US); Adrian A. BRUNO, Rolling Meadows, IL (US)

(73) Assignee: WEBER-STEPHEN PRODUCTS CO., Palatine, IL (US)

(21) Appl. No.: 13/089,893

(22) Filed: Apr. 19, 2011

(51) Int. Cl. A47J 37/00

(52) U.S. Cl. 126/25 R

(57) ABSTRACT

In one embodiment, a barbecue grill assembly includes a cooking grate positioned in an upper portion of a cooking chamber, a heat and grease deflecting apparatus positioned in a lower portion of the cooking chamber, and a heat source positioned between the cooking grate and the heat and grease deflecting apparatus. The heat and grease deflecting apparatus not only reduces heat loss from the cooking chamber during the operation of the barbecue grill by slowing the travel of hot grease and ignited particles form the cooking grate to the grease collecting tray, but also reduces the occurrences of grease fires in the cooking chamber.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF PARTIES TO A JOINT RESEARCH AGREEMENT

Not Applicable.

### INCORPORATION-BY-REFERENCE OF MATERIAL SUBMITTED ON A COMPACT DISC

Not Applicable.

### BACKGROUND OF THE INVENTION

1. Technical Field

The embodiments described and claimed herein relate generally to a heat and grease deflecting apparatus (or a heat and grease deflector) that is positioned below a heat source in a barbecue grill. More specifically, the embodiments described herein are directed to heat and grease deflecting members that deflect heat upwards towards the heat source, and that deflect grease downwards away from the heat source.

2. Background Art

The popularity of barbecue grills and outdoor cooking devices has increased tremendously over the last several decades. Initially, charcoal barbecue grills having combustible solid fuel were utilized to cook food via radiant and convective heat. Subsequently, gas barbecue grills which employ a gas burner have been utilized. The gas barbecue grills generally cook the food via radiant and convective heat. Often, the food to be cooked in both charcoal and gas grills is situated on a grid-like cooking grate having numerous elongated bars and openings. Accordingly, to cook food in such barbecue grills, the radiant and convective heat energy dispelled from either the charcoal or gas burners passes through the cooking grate and is directed at the food.

Furthermore, such conventional gas grills generally include a burner assembly adjacent the lower portion of a firebox with a cooking grid supported along the upper edge thereof. Lava rock or some other ancillary conductive member is generally located between the cooking grid and the burner assembly. The lava rock operates as a form of a conductive member which absorbs the convective heat from the burning gas, and which subsequently provides a generally uniform convective heat-emitting means for the food being cooked on the cooking grate. Unfortunately, grease and other combustible particles build up on the lava rock and cause undesirable flare ups and hot spots within the grilling cavity. Additionally, the lava rocks have to be replaced periodically due to degradation.

Accordingly, the Assignee of the present invention previously developed a gas grill which eliminated the need for lava rock. Such grills are disclosed in U.S. Pat. Nos. 4,677,964; 5,765,469; and, 5,934,183. The gas grills disclosed therein have revolutionized the gas grill industry by eliminating the need for the lava rock. The gas grills disclosed in the above-noted patents utilize sear bars which are positioned between the cooking grid and the gas burners to vaporize any greases that emanate from the food being cooked. Like the lava rock, the sear bars operate as a remote conductive member between the gas burner and the cooking grate. The conductive sear bars emit convective energy which is partially directed at the food on the cooking grate to cook the food. Some of the convective energy, however, leaks out from the cooking chamber as all of the heat produced by the heat source cannot be contained within the cooking chamber.

In this regard, even though the revolutionary gas grills identified above utilize a different type of fuel and a different type of conductive member, these grills as well as the charcoal grills lose heat from the cooking chamber to the surroundings. As a result, the heat source ends up burning more fuel than necessary. As more fuel is burned, more grease and other byproducts are produced during the grilling process. The production of more grease and by-products in turn increases the possibility and occurrences of grease fires within the cooking chamber.

### BRIEF SUMMARY OF THE INVENTION

According to the present inventions, a barbecue grill has been designed that not only reduces heat loss from the cooking chamber during the operation of the barbecue grill but also reduces the occurrences of grease fires in the cooking chamber.

In one embodiment, a barbecue grill assembly includes a cooking grate positioned in an upper portion of a cooking chamber, a heat and grease deflecting apparatus positioned in a lower portion of the cooking chamber, and a heat source positioned between the cooking grate and the heat and grease deflecting apparatus. In this embodiment or in a second embodiment, the barbecue grill assembly further includes a plurality of sear bars positioned below the cooking grate and above the heat source.

In one embodiment, the cooking chamber includes an open bottom, wherein the open bottom is an opening in the bottom of the cooking chamber. In this embodiment, the open bottom allows air into the cooking chamber and allows hot grease particles to drip down to a grease collecting tray, and wherein the heat and grease deflecting apparatus partially closes the open bottom of the cooking chamber to interrupt the flow of hot grease particles.

In another embodiment, the heat and grease deflecting apparatus includes inclined surfaces to slow down hot grease particles, and wherein the heat and grease deflecting apparatus deflects heat upwards from the lower portion of the cooking chamber towards the cooking grate and deflects grease downwards towards the lower portion of the cooking chamber.

In another embodiment, the heat and grease deflecting apparatus includes a plurality of heat and grease deflecting members. In this embodiment, each heat and grease deflecting member is an inverted V-shaped member, wherein each inverted V-shaped member has a first inclined surface and a second inclined surface. The first and second inclined surfaces of each inverted V-shaped member generally merge at an apex to define an internal angle that is greater than 90 degrees (i.e., an obtuse angle). In the same embodiment or a different embodiment, each of the first and second inclined surfaces of each inverted V-shaped member has a plurality of openings allowing air to pass from the deflecting apparatus to the heat source and to allow grease to drip down and away from the heat source towards the lower portion of the cooking chamber.

The contemplated design has several advantages. First, heat loss from the cooking chamber is reduced as each of the inverted V-shaped members partially closes the open bottom of the cooking chamber and deflects heat upwards away from the lower portion of the firebox towards the heat source. In one particular test, Applicant found that the contemplated design allows the barbecue grill to save about 4,000 British Thermal Units (BTUs). The openings in the heat and grease deflecting members allow fresh air to pass upwards from the lower portion of the firebox (via the open bottom) towards the heat source, thereby facilitating combustion. Second, the heat source burns less fuel as more heat is retained in the cooking chamber.

Third, the occurrences of grease fires are reduced because the heat and grease deflectors partially block the opening in the bottom of the firebox, thereby preventing burning grease and food particles from dropping directly into a grease drip tray while still ignited. The inclined construction of the heat and deflecting apparatus slows or delays the travel of the hot or flaming grease and other byproducts or particles to the tray. Further, the internal angle of each of the inverted V-shaped member is optimized to allow grease to drip away from the heat source towards the lower portion of the firebox. The angle is such that it allows the grease to flow slow enough to prevent grease fires but fast enough to prevent grease from solidifying on the deflecting apparatus. In this regard, the openings in the deflecting apparatus assist by shortening the distance a given grease droplet can travel before dropping in the grease collecting tray.

### BRIEF DESCRIPTION OF THE DRAWINGS

These and other features, aspects, objects, and advantages of the embodiments described and claimed herein will become better understood upon consideration of the following detailed description, appended claims, and accompanying drawings where:

FIG. 1 is a perspective view of a barbecue grill;

FIG. 2 is an exploded view of the barbecue grill;

FIG. 3A is a perspective view of a first embodiment of a heat and grease deflecting member;

FIG. 3B is a cross-sectional view of the same;

FIG. 4 is a schematic of the operation of the barbecue grill and the heat and grease deflecting member of FIG. 3; and

FIG. 5 is a perspective view of a portion of a firebox.

It should be understood that the drawings are not necessarily to scale and that the embodiments are sometimes illustrated by graphic symbols, phantom lines, diagrammatic representations and fragmentary views. In certain instances, details which are not necessary for an understanding of the embodiments described and claimed herein or which render other details difficult to perceive may have been omitted. It should be understood, of course, that the inventions described herein are not necessarily limited to the particular embodiments illustrated. Indeed, it is expected that persons of ordinary skill in the art may devise a number of alternative configurations that are similar and equivalent to the embodiments shown and described herein without departing from the spirit and scope of the claims.

Like reference numerals will be used to refer to like or similar parts from figure to figure in the following detailed description of the drawings.

### DETAILED DESCRIPTION OF THE INVENTIONS

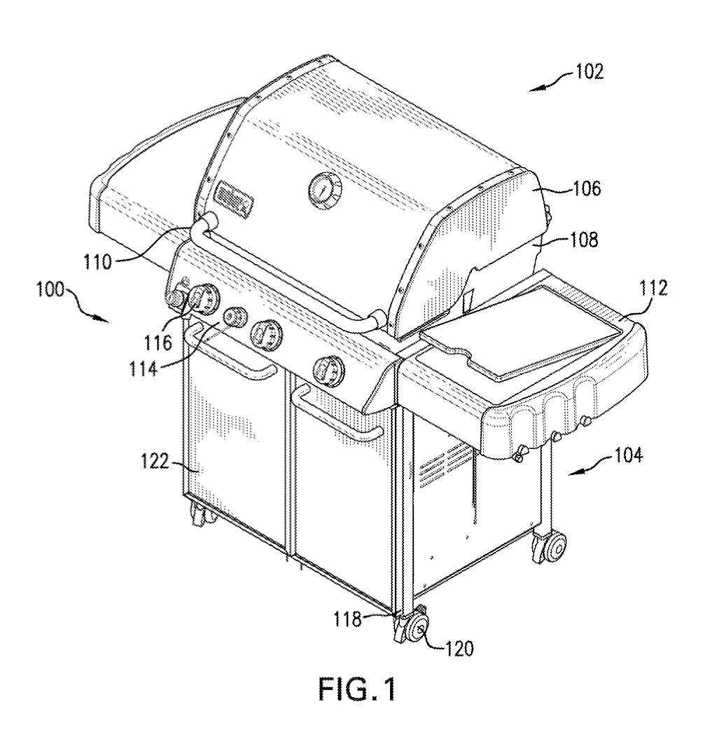

Referring first to FIG. 1, a barbecue grill 100 is shown in perspective view. As shown in FIG. 1, the barbecue grill 100 includes a cooking chamber 102 and a grill cart (or frame assembly) 104. The cooking chamber 102, in turn, includes a lid 106, a firebox 108, and a handle 110. The frame assembly 104, in turn, includes four support legs 118, each support leg having a corresponding wheel 120, a set of doors 122, two side-shelves 112, a control panel 114, and a plurality of control knobs 116.

In one embodiment, the lid 106 is hingedly attached to the firebox 108. The firebox 108, in turn, is secured to the grill cart 104. The firebox 108 may be secured to the grill cart 104 by way of bolts, brackets, and/or screws (not shown). The grill cart 104 is generally for supporting the cooking chamber 102, side shelves 112, the control panel 114, and other associated components, such as a fuel or gas tank and a grease drip tray or pan.

In operation, the cooking chamber 102 is used to cook food. Generally, a heat source (not shown in FIG. 1) in the firebox 108 heats up the cooking chamber 102. In one embodiment, the heat source comprises a plurality of gas burner tubes.

It should be understood that alternative embodiments of the barbecue grill 100 may include additional or other components. As an example, in an alternative embodiment, the lid 106 may be entirely removable from the firebox 108 and the lid 106 need not be hingedly attached to the firebox 108. As another example, in an alternative embodiment, the barbecue grill 100 may include an H-shaped burner or any other shaped burner (e.g., loop-shaped burner) as the heat source. In another embodiment, the barbecue grill 100 may include a charcoal grate for holding charcoal briquettes as the heat source. In yet another embodiment, the barbecue grill 100 may include an electric burner or any other type of burner as the heat source.

Further, as another example, the barbecue grill 100 may include additional burners in side-shelves 112. As yet another example, the barbecue grill 100 may include a grease management system, which may include a drip tray, a grease drip pan, and/or a tank blocking structure positioned below the firebox 108.

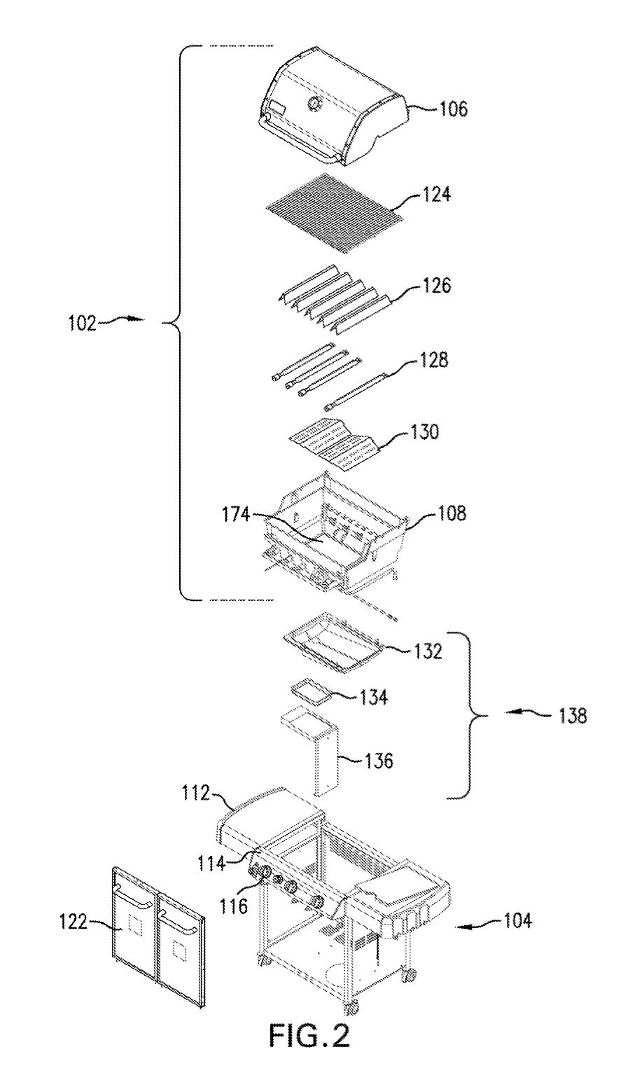

Turning to FIG. 2, an exploded perspective view of the barbecue grill 100 is provided illustrating the inner components of the cooking chamber 102 as well as a grease management system 138 positioned below the firebox 108. As shown in FIG. 2, the grease management system 138 includes a grease drip tray 132, a grease drip pan 134, and a tank blocking structure 136. Further, the cooking chamber 102 includes, in addition to the lid 106 and the firebox 108, a cooking grate 124, a plurality of sear bars 126, a plurality of burner tubes 128, and a heat and grease deflecting apparatus 130. The firebox 108 has an open bottom 174 so that grease can fall into the grease drip tray 132. Open bottom 174 is an opening in the bottom of the firebox 108. In the embodiment shown, open bottom 174 is rectangularly shaped (i.e., the opening in the bottom of the firebox 108 is rectangularly shaped).

Before describing each of the inner components of the cooking chamber 102 in further detail, the relative arrangement of each of the inner components of the cooking chamber 102 should be noted. As shown in FIG. 2, the plurality of sear bars 126 are generally positioned below the cooking grate 124 but above the plurality of burner tubes 128. The plurality of burner tubes 128, in turn, are positioned below the plurality of sear bars 126 but above the heat and grease deflecting apparatus 130. Described another way, the plurality of sear bars 126 are generally positioned in between the cooking grate 124 and the plurality of burner tubes 128. The plurality of burner tubes 128 are in turn positioned in between the plurality of sear bars 126 and the heat and grease deflecting apparatus 130. In this regard, the cooking grate 124 is generally positioned in an upper portion of the firebox 108 and the heat and grease deflecting apparatus 130 is generally positioned in a lower portion of the firebox 108.

Now turning to each of the inner components of the cooking chamber 102, the cooking grate 124 generally defines a cooking surface upon which food is placed during operation of the barbecue grill 100 and is generally positioned in an upper portion of the firebox 108. In one embodiment, the cooking grate 124 rests on a first ledge located in the upper portion of the firebox 108.

Generally, the plurality of burner tubes 128 heat up the cooking chamber 102 during operation of the barbecue grill. As explained above in connection with FIG. 1, the barbecue grill 100 may use a different heat source other than the gas burner tubes 128. For instance, in an alternative embodiment, the barbecue grill 100 may use charcoal briquettes as the heat source. In such an embodiment, the barbecue grill 100 includes a charcoal grate for holding the charcoal briquettes. The barbecue grill 100 may use other types of heat sources, such as electric burners, in other embodiments.

Regardless of the type of heat source that barbecue grill 100 uses, the heat source is generally positioned between the plurality of sear bars 126 and the heat and grease deflecting apparatus 130. In one embodiment, the heat source is positioned at a fixed distance below the plurality of sear bars 126 but above the heat and grease deflecting apparatus 130.

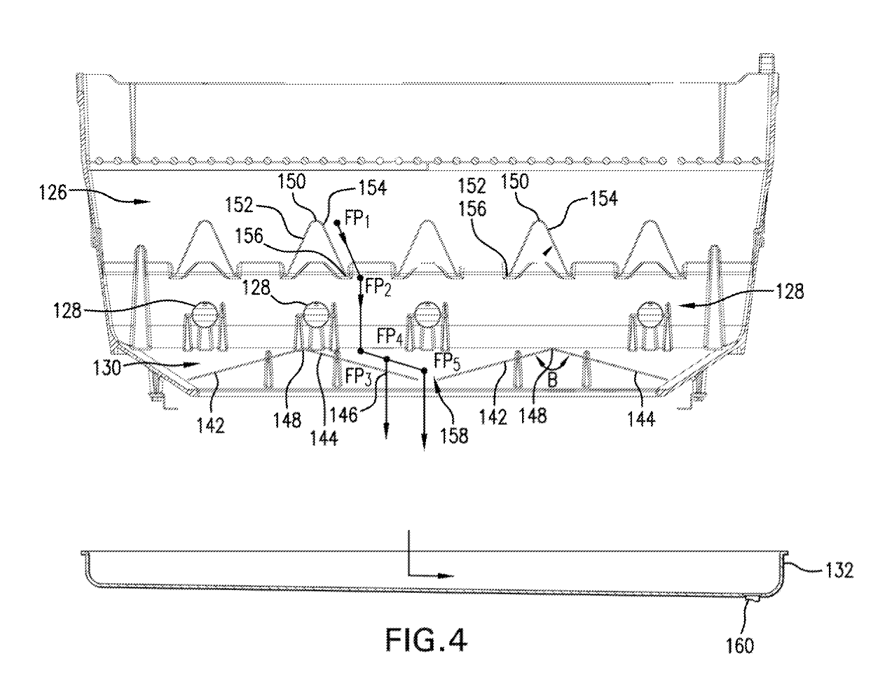

The sear bar 126 is explained more fully in connection with FIG. 4, but as a general matter, it should be noted that the sear bar 126 generally prevents grease and other by-products (generated during the grilling process) from coming in contact with the flames produced by the plurality of burner tubes 128. By preventing grease from coming in direct contact with the flames, the sear bars 126 prevent flare-ups and grill fires. As noted above, the plurality of sear bars 126 are generally positioned at a fixed distance below the cooking grate 124 and at a fixed distance above the plurality of burner tubes 128. In one embodiment, the plurality of sear bars 126 rest on a second ledge below the first ledge in the firebox 108.

In one embodiment, each sear bar 126 comprises an inverted V-shaped member having two inclined surfaces that merge together at an apex to define an internal angle that is less than 90 degrees (i.e., an acute angle). In this regard, each sear bar 126 is an acutely shaped inverted V-shaped member. Preferably, the two sides of the inverted V-shaped member have a sufficient transverse dimension to fully cover at least one burner tube 128 so that the grease will not impinge directly onto the flames.

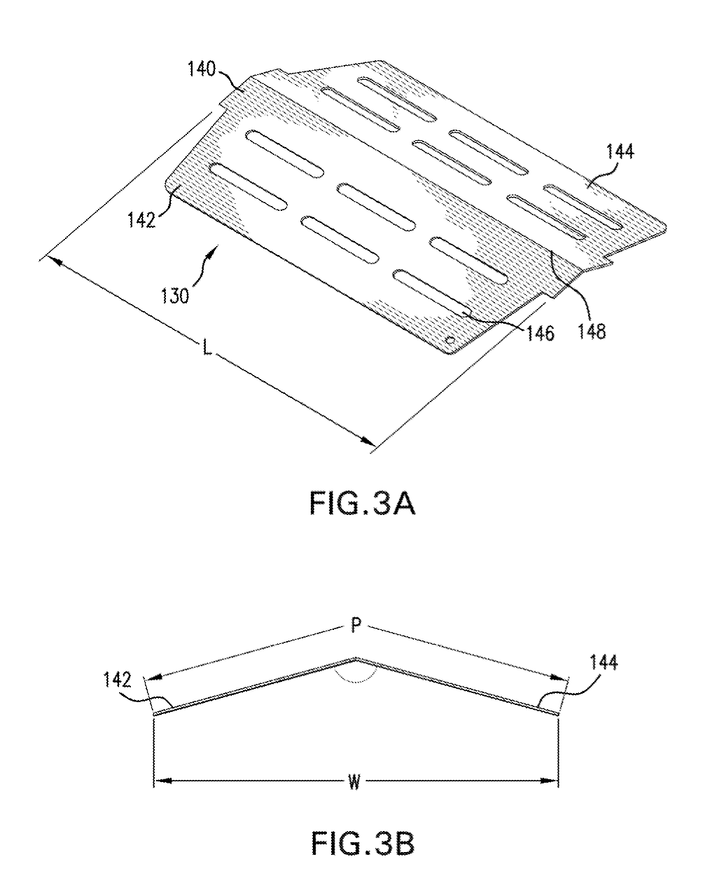

The heat and grease deflecting apparatus 130 is explained more fully in connection with FIGS. 3 and 4, but as a general matter it should be noted the heat and grease deflecting apparatus 130 partially closes the open bottom 174 of the firebox 108 and deflects heat from the lower portion the firebox 108 towards the cooking grate 124. Further, the heat and grease deflecting apparatus 130 interrupts the flow of hot grease particles and deflects grease that drops from the sear bars 126 during the operation of the barbecue grill 100 to slow their travel to the grease management system 138 and allow ignited particles to extinguish before they drop into the grease drip tray 132. In doing so, the heat and grease deflecting member 130 assist in adding flavor to the food that is being cooked on the cooking grate 124. Further, the heat and grease deflecting member 130 has openings to interrupt the flow of grease from travelling directly down from sear bar 126 to grease management system 138.

The heat and grease deflecting apparatus 130 is positioned at a fixed distance below the plurality of burner tubes 128. The heat deflecting apparatus 130 includes a plurality of heat and grease deflecting members 130. Each heat and grease deflecting member 130 is an inverted V-shaped member having two inclined surfaces that merge together at an apex to define an internal angle that is greater than 90 degrees (i.e., an obtuse angle). In this regard, each heat and grease deflecting member is an obtusely shaped inverted V-shaped member.

In operation of the barbecue grill 100, the grease and other by products produced during the grilling process gradually drip down from the heat and grease deflecting apparatus 130 and into the grease management system 138. Typical grease management systems, like the one illustrated in FIG. 2, are designed to direct grease away from the cooking chamber 102 (where the high heat can cause grease fires) to an area of lower temperature which is typically below the cooking chamber 102. As shown in FIG. 2, the grease management system 138 includes a grease drip tray 132, a grease drip pan 134, and a tank blocking structure 136. The grease drip tray 132 captures grease dripping from one or more openings in the heat and grease deflecting apparatus 130 and directs the grease to the grease drip pan 134. The grease drip pan 132 preferably has an inclined bottom surface that assists in draining the grease and other by-products towards the grease drip pan 134. The tank blocking structure 136 preferably compartmentalizes the interior of the grill cart 104 such that only one fuel tank can be placed at the interior of the grill cart 104 at any one time. It should be understood that the grease management system 130 may include other or additional components.

FIGS. 3A and 3B provide different views of the heat and grease deflecting apparatus 130. FIG. 3A provides a perspective view of the heat and grease deflecting apparatus 130. And FIG. 3B provides a cross-sectional view of the heat and grease deflecting apparatus 130.

With reference to FIGS. 3A and 3B, the heat deflecting apparatus 130 includes a pair of lips 140, a first side 142, a second side 144, and a plurality of openings 146. The lips 140 allow the heat and grease deflecting member 130 to rest on a ledge in the lower portion of the firebox 108. The first side 142 and the second side 144 merge together at an apex 148 to form an obtusely shaped inverted V-shaped member. In this regard, as shown in FIG. 3B, the first inclined surface 142 and the second inclined surface 144 of the heat and grease deflecting apparatus 130 merge at an upper apex 148 to define an obtuse internal angle B (i.e., an angle that is greater than 90 degrees).

The heat and grease deflecting member 130 is optimally designed with certain dimensions. For instance, as noted above, the first inclined surface 142 and the second inclined surface 144 merge at an upper apex 148. This configuration of having two inclined surfaces advantageously prevents grease and other by-products to collect or remain stagnant in any particular area or portion of the heat and grease deflecting member 130.

Further, as noted above, the inclined surfaces 142 and 144 merge to form an inverted V-shaped member, which is positioned between the open bottom 174 and the burner tubes 128. The inverted V-shaped members partially close the open bottom 174 of the firebox 108. This configuration of the heat and grease deflecting member 130, which partially closes the bottom portion 174 of the firebox 108, advantageously prevents the burning grease or ignited food particles from dropping directly into the grease drip tray 132 while still ignited. In addition, the inclined sides 142 and 144 provide a flow path for the grease and assist in extinguishing any flames on any burning grease particles (or by-products, and/or food particles) before the grease (or by-products, and/or food particles) reach the grease drip tray 132.

Still further, as noted above, the inclined surfaces 142 and 144 merge at an apex to define an obtuse angle. In the shown embodiment, the obtuse internal angle B is approximately 150 degrees. The obtuse angle B is optimized so that heat and grease deflecting member 130 not only slows down or delays the flow of the grease on the member 130 thereby extinguishing any flaming or burning grease particles (or burning food particles that may have dropped down from the cooking grate 124 or burning by-products) before the particles reach the grease management system 138 (or the grease drip tray 132) but also keeps the grease particles (or food particles or by-products) moving fast enough to prevent them from solidifying. In other words, the sides 142 and 144 are inclined to have an optimal angle that prevents or reduces the occurrences of grease fires in the firebox 108.

In the embodiment shown, the heat and grease deflecting member 130 has a width of about 8 inches (indicated by the letter W in FIG. 3B), a length of approximately 13 inches from lip to lip (indicated by the letter L in FIG. 3A), and a outer perimeter of approximately 9 inches from the edge of the first side 142 to the edge of the second side 144 (indicated by the letter P in FIG. 3B). In this regard, the outer perimeter P is generally greater than width W. By having the outer perimeter P to be greater than the width W, the time for which hot grease, by-products, and other particles can travel alongside surface 142 or 144 is increased. By increasing the time that the grease traverses in the firebox 108, the heat and grease deflecting member 130 assists in extinguishing or exhausting any grease particles or by-products that may be burning before reaching the grease management system 138.

Further, in the embodiment shown, the heat and grease deflecting member 130 has a total of 12 openings, where the first side 142 has 6 openings and the second side 144 has another 6 openings. Openings 146 advantageously interrupt the flow of grease on the heat and grease deflecting member 130 and reduces the distance grease travels before dropping to the grease drip tray 132. Further, the plurality of openings 146 also allow air to pass upwards from the lower the portion of the firebox 108 towards the cooking grate 124. In allowing to air to pass upwards, the openings allow heat to be deflected upwards, and thereby prevent heat loss from the cooking chamber 102. Further, as explained above, the openings allow grease and other by-products produced the grilling process to drip down and away from the burner tubes 128 towards the grease management system 138.

The openings 146 on each of sides 142 and 144 are arranged in two rows. Each row has three openings. Each opening in a given row, in turn, is equidistant from another opening in that row. In the embodiment shown, each opening 146 has a length of approximately 3 inches and a width of approximately 0.4 inches. In this regard, as shown in FIG. 3A, opening 146 is an oblong oval shaped opening. In any given row, the distance from the center of one opening 146 to the center of another adjacent opening 146 in that same row is approximately 4 inches.

The embodiment shown has several advantages. First, since the heat and deflecting apparatus has inclined surfaces 142 and 144, grease and other by products are not allowed to collect or remain stagnant in any particular area of the heat and grease deflecting member 130.

Second, the heat and grease deflecting apparatus 130 reduces the chances of grease fires in the cooking chamber 102. The angle at which inclined surfaces 142 and 144 merge at the apex 148 is optimized such that the grease travels slow enough so that any burning grease particles are extinguished or exhausted but fast enough so that the grease particles do not solidify as the grease particles cool down. Further, the openings 146 are spaced apart in two rows that assist in preventing the grease from solidifying by allowing grease, by products, and/or other particles to drip down into the grease management system 138. The obtuse angle of the heat and grease deflecting member 130 allows any grease and other by products that may have ignited during the cooking process to be extinguished or exhausted. In this regard, the heat and grease deflecting apparatus 130 decreases the occurrences of grease fires in the firebox 108.

Third, the heat and grease deflecting member 130 allows less fuel to be burned. In particular, the inclined surfaces 142 and 144 partially close the lower portion of the firebox 108 and the openings 146 allow fresh air to pass from the lower portion of the firebox 108 towards the cooking grate 124. By partially closing the lower portion of the firebox 108, heat from the burner tubes 128 is directed upwards.

Fourth, the heat and grease deflecting member 130 allows heat to be deflecting upwards from the burner tubes 128 towards the cooking grate 124. In particular, the inverted V-shaped member formed by the inclined surfaces 142 and 144 deflects heat upwards towards the cooking grate 124.

Turning to FIG. 4, an enlarged cross-sectional view of a sear bar 126, a burner tube 128, and a heat deflecting apparatus 130 is shown. As shown in FIG. 4, the sear bar 126 includes a first inclined surface 152 and a second inclined surface 154. The first inclined surface 152 and the second inclined surface 154 merge at an apex 150 to define an internal angle A, which is less than 90 degrees. In this regard, internal angle A is an acute angle, and sear bar 126 is an acutely shaped inverted V-shaped member.

Further, heat and grease deflecting apparatus 130 includes a first inclined surface 142 and a second inclined surface 144. The first inclined surface 142 and the second inclined surface 144 merge together at an apex 148 to define an internal angle B, which is greater than 90 degrees. Internal angle B, therefore, is an obtuse angle, and heat and grease deflecting apparatus 130 is an obtusely shaped inverted V-shaped member.

The different internal angles (i.e., internal angle A and internal angle B) allows the grease to travel at different rates. In this regard, grease travels down the sear bar 126 at a quicker rate than when travelling down the heat and grease deflecting apparatus 130. Because the grease travel down the heat and grease deflecting apparatus 130 at a slower rate.

FIG. 4 also illustrates how grease is deflected downwards and away from the burner tubes 128 during the operation of the barbecue grill 100. As shown in FIG. 4, grease comes into contact with a portion of the sear bar 126 and flows along the sear 126 to define a flow path FP whereby the grease is prevented from coming in contact with the burner tube 128. Typically, grease first comes into contact with either the inclined surfaces 152 or 154 at an upper portion of the surfaces 152 or 154 near the peak 150.

The point where grease first contacts the inclined surface 154 defines the beginning or first point FP1 of the flow path FP. Due to the inclined configuration of the sear bar 126, the flow path FP of grease continues along the surface 154 until it reaches the edge 156. There, the flow path FP experiences a change in direction due to the change in geometry of the sear bar 126. The point where the flow path FP changes direction occurs proximate the edge 156 and defines a second point FP2 of the flow path FP. Due to the effects of gravity and the geometry of the sear bar 126 at the edge 156, grease in the flow path FP generally loses contact with the sear bar 126 and the grease passes or drops to the surface 142 of the heat and grease deflecting member 130. Since the edge 156 extends beyond the outer wall 158 of the burner tube 128, the grease does not contact the burner tube 128 as it drops towards the heat and grease deflecting member 130.

Upon reaching the inclined surface 144 of the heat and grease deflecting member 130, the flow path FP experiences a change in direction due to geometry of the heat and grease deflecting member 130. As shown in FIG. 4, the point where the flow path FP changes direction occurs proximate the inclined surface 144 and defines a third point FP3 of the flow path FP. At point FP3, the grease is now in contact with surface 144. Due to the effects of gravity, the grease remains in contact with surface 144 and continues downwards along the surface 144 until reaching an opening 146.

At the opening 146, the flow path FP experiences a change in direction due to the change in geometry of the heat and grease deflecting member 130. The point where the flow path FP changes direction occurs proximate the opening 146 and defines a fourth FP4 of the flow path FP. Upon reaching the opening 146, a portion of the grease loses contact with the inclined surface 144 and falls downwards towards grease drip tray 132 of the grease management system 138.

The distance between FP3 and FP4 is long enough to allow any ignited grease particles (e.g., or food particles of other by-products, or food products) to extinguish. Further, the angle at which grease travels between FP3 and FP4 allows grease to travel slow enough so that any burning grease particles are extinguished or exhausted but fast enough so that the grease particles do not solidify as the grease particles cool down Any grease that does not fall through the opening 146 on the inclined surface 144 of the heat and grease deflecting member 130 generally traverses until it reaches gap 158 between two adjacent heat and grease deflecting apparatuses. There, this grease in the flow path FP experiences a change in direction due to the variation in geometry of the heat and grease deflecting member 130 at the inclined surface 144. The point where the flow path FP changes direction occurs near where inclined surface 144 ends and defines a fifth point FP5 of the flow path FP. Upon reaching the gap 158, the remaining grease falls downwards to grease drip tray 132, where the grease flows towards a drain 160.

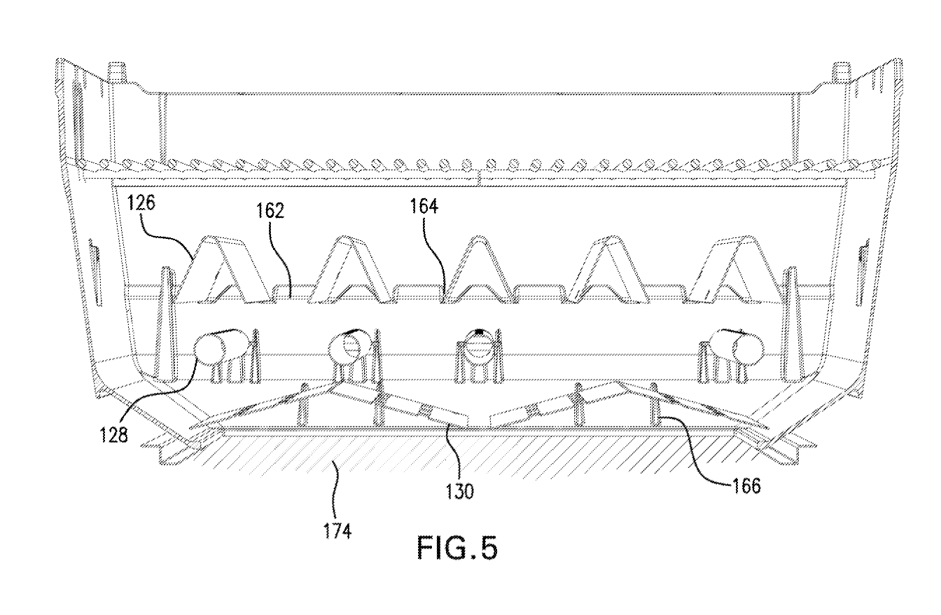

FIG. 5 illustrates a perspective view of a portion of the firebox 108 according to one embodiment. As shown in FIG. 5, the firebox 108 includes the plurality of sear bars 126, a ledge 162, a plurality of positioning members 164, the plurality of burner tubes 128, a plurality of ledges 166 (or holding mechanism 166), and the open bottom 174. The open bottom 174 is an opening in the bottom of the firebox 108. It should be understood that other embodiments of the firebox 108 could include other resting members to assist in holding up either the plurality of sear bars 126 or the heat and grease deflecting members 130.

The plurality of sear bars 126 rest on the ledge 162, which is generally positioned at a fixed distance above the burner tubes 128. The positioning members 164 generally assist in maintaining a predetermined spacing between each of the sear bars 126. The plurality of ledges 166 are positioned at a fixed distance below the burner tubes 128, preferably in the lower portion of the firebox 108. The heat and grease deflecting members 130 (not shown in FIG. 5) rest on the plurality of inclined ledges 166. In one embodiment, a lip 140 of the heat and grease deflecting members 130 (shown in FIG. 3) rest on the ledges 166 and in doing so, partially close the open bottom 174 of the firebox 108.

Although the inventions described and claimed herein have been described in considerable detail with reference to certain embodiments, one skilled in the art will appreciate that the inventions described and claimed herein can be practiced by other than those embodiments, which have been presented for purposes of illustration and not of limitation. Therefore, the spirit and scope of the appended claims should not be limited to the description of the embodiments contained herein.

We claim:

1. A barbecue grill assembly comprising:
a cooking chamber;
a cooking grate positioned in an upper portion of the cooking chamber;
a heat and grease deflecting apparatus positioned in a lower portion of the cooking chamber; and
a heat source positioned between the cooking grate and the deflecting apparatus.

2. The barbecue grill assembly of claim 1, further comprising:
a plurality of sear bars positioned below the cooking grate and above the heat source, wherein the cooking grate supports food to be cooked in the cooking chamber; and
a grease tray for collecting grease, wherein the grease tray is positioned below the heat and grease deflecting apparatus.

3. The barbecue grill assembly of claim 1, wherein the cooking chamber includes an open bottom, wherein the open bottom is an opening in the bottom of the cooking chamber, wherein the open bottom allows air into the cooking chamber and allows hot grease particles to drip down to a grease tray, and wherein the heat and grease deflecting apparatus partially closes the open bottom of the cooking chamber to interrupt the flow of hot grease particles.

4. The barbecue grill assembly of claim 1, wherein the heat and grease deflecting apparatus includes inclined surfaces to slow down hot grease particles, and wherein the heat and grease deflecting apparatus deflects heat upwards from the lower portion of the cooking chamber towards the cooking grate and deflects grease downwards towards the lower portion of the cooking chamber.

5. The barbecue grill assembly of claim 1, wherein the heat and grease deflecting apparatus comprises a plurality of inverted V-shaped members, wherein each inverted V-shaped member has a first inclined surface and a second inclined surface.

6. The barbecue grill assembly of claim 5, wherein the first and second inclined surfaces of each inverted V-shaped member merge at an upper apex to define an internal angle that is greater than 90 degrees.

7. The barbecue grill assembly of claim 6, wherein the internal angle is about 150 degrees.

8. The barbecue grill assembly of claim 5, wherein each of the first and second inclined surfaces of each inverted V-shaped member has a plurality of openings, the plurality of openings on each of the first and second inclined surfaces are arranged in two rows of openings, wherein each row of openings is parallel to each other, wherein each row interrupts a grease pathway from the upper apex of the inverted V-shaped member, and wherein the plurality of openings allow air to pass from the lower portion of the cooking chamber towards the cooking grate and to allow grease to drip downwards and away from the heat source towards the lower portion of the cooking chamber.

9. The barbecue grill assembly of claim 8, wherein each inverted V-shaped member has 12 openings, wherein each of the inclined surfaces of each inverted V-shaped member has 6 openings, and wherein each row has 3 openings.

10. The barbecue grill assembly of claim 1, wherein the heat source comprises a gas burner, an electric burner, or charcoal briquettes on a charcoal grate.

11. A cooking chamber of a barbecue grill assembly, the cooking chamber comprising:
a cooking grate for supporting food to be cooked, the cooking grate positioned in an upper portion of the cooking chamber, the cooking chamber having an open bottom;
a plurality of gas burner tubes positioned in a lower portion of the cooking chamber;
a plurality of sear bars positioned in between the cooking grate and the plurality of gas burner tubes; and
a plurality of heat and grease deflecting members positioned below the plurality of gas burner tubes, wherein the plurality of heat deflecting members partially close the open bottom of the cooking chamber.

12. The cooking chamber of claim 11, wherein at least one of the plurality of heat and grease deflecting members includes at plurality of openings, wherein the plurality of openings are arranged in rows, wherein each row has at least 3 openings, wherein the openings interrupt the flow of grease and allow fresh air to flow from the lower portion of the cooking chamber towards the upper portion of the cooking chamber.

13. The cooking chamber of claim 11, wherein each of the plurality of sear bars positioned between the cooking grate and the plurality of gas burner tubes comprises an acutely shaped inverted V-shaped member having a first apex that defines a first internal angle.

14. The cooking chamber of claim 13, wherein at least one sear bar is positioned directly over and covers at least one gas burner tube.

15. The cooking chamber of claim 13, wherein each of the plurality of heat and grease deflecting members positioned below the plurality of gas burner tubes comprises an obtusely shaped inverted V-shaped member having a first inclined surface and a second inclined surface, wherein the first and second inclined surfaces merge at a second apex to define a second internal angle.

16. The cooking chamber of claim 15, wherein the second internal angle of the obtusely shaped inverted V-shaped member is an obtuse angle, the first internal angle of the acutely shaped inverted V-shaped member is an acute angle, and where the second internal angle is greater than the first internal angle.

17. The cooking chamber of claim 16, wherein at least one of the first and second inclined surfaces of the obtusely shaped inverted V-shaped member assist in deflecting grease downwards along at least one of the first and second inclined surfaces.

18. The cooking chamber of 15, wherein at least one of the first and second inclined surfaces of the obtusely shaped inverted V-shaped member includes six openings, wherein the six openings are arranged in two rows of openings arranged parallel to each other, each row having three openings, wherein each opening interrupts a grease pathway, and wherein each opening allows air to flow from the lower portion of the cooking chamber to the upper portion of the cooking chamber and allows grease to drip down and away from the heat source towards the lower portion of the cooking chamber.

19. The cooking chamber of claim 11, further comprising:
a grease tray positioned below the deflecting apparatus, wherein the grease tray collects grease.

20. A cooking chamber of a barbecue grill assembly, the cooking chamber comprising:
an open bottom, wherein the open bottom is an opening in the bottom of the cooking chamber;
a cooking grate for supporting food to be cooked, the cooking grate positioned in an upper portion of the cooking chamber;
a plurality of gas burner tubes positioned in a lower portion of the cooking chamber;
a plurality of sear bars positioned in between the cooking grate and the plurality of gas burner tubes, wherein each of the plurality of sear bars positioned between the cooking grate and the plurality of gas burner tubes comprises an acutely shaped inverted V-shaped member having a first inclined surface and a second inclined surface, wherein the first and second inclined surfaces merge at a first apex to define a first internal angle; and
a plurality of heat and grease deflecting members positioned below the plurality of gas burner tubes, wherein the plurality of heat and grease deflecting members partially close the open bottom of the cooking chamber, and wherein each of the plurality of heat and grease deflecting members positioned below the plurality of gas burner tubes comprises an obtusely shaped inverted V-shaped member having a first inclined surface and a second inclined surface, wherein the first and second inclined surfaces of the obtusely shaped inverted V-shaped member merge at a second apex to define a second internal angle, wherein the second internal angle is greater than the first internal angle, and wherein each of the first and second inclined surfaces of the obtusely shaped inverted V-shaped member has two rows of openings, and wherein each row of opening has three openings, and wherein each opening interrupts the flow of grease.
